(19) United States
(12) Patent Application Publication
(10) Pub. No.: US 2007/0024995 A1
(43) Pub. Date: Feb. 1, 2007

(54) Light beam emitter and image-forming device

(76) Inventor: Kenichi Hayashi, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/485,012

(22) Filed: Jul. 12, 2006

(30) Foreign Application Priority Data
Jul. 12, 2005 (JP) 2005-202596

(51) Int. Cl. G02B 5/08

(52) U.S. Cl. 359/838

(57) ABSTRACT

The present invention provides a light beam emitter that has a simple construction and can direct a light beam toward any positions on the 2D coordinate system, and an image-forming device. In a light beam emitter, an light deflection mechanism has a transmissive light deflection disk, equipped with light deflection areas from which the incident light beam exits toward different positions on the 2D coordinate system depending on the incident positions of the beam, and a drive mechanism that rotates the transmissive light deflection disk in order to change the position of the light beam emitted by the light source device to enter the transmissive light deflection disk.

### FIELD OF THE INVENTION

The present invention relates to a light beam emitter that directs the light beam emitted by a light source device in predetermined directions, and also relates to an image-forming device that forms an image with the light beam.

### BACKGROUND OF THE INVENTION

Conventionally a light beam emitter has been widely used in image-forming devices, such as a laser printer, digital copy machine and fax machine, a bar-code reader, or an inter-vehicle distance measuring device. In a light beam emitter used in an image-forming device, a light beam emitted by a laser photo device such as laser diode is periodically deflected by a polygonal mirror to repeatedly scan a surface to be scanned such as a photo sensitive body. Also, in the inter-vehicle distance measuring device, the scanning beam emitted by a light beam emitter is reflected on a body to be irradiated and the reflected beam is detected by a photo detector to detect information. At that time, the reflected beam is guided toward the photo detector at the angle of incidence corresponding to the angle of scanning by the polygonal mirror. Note that, besides the method of rotating a polygonal mirror, another scanning method may be used in which a reflective plate is swung to scan with the light beam within a predetermined range of angles. (See Tokkai H11-14922 and Tokkai H11-326806)

However, in a conventional light beam emitter, the light beam scans only in the main scanning direction, that is, only one-dimensional scanning is performed; therefore, an additional drive mechanism needs to be provided to scan in the secondary scanning direction in order to form a two-dimensional image using the emitted light beam. Thus, a conventional image-forming device results in a complicated, larger structure with heavier weight.

Considering the above problem, the objective of the present invention is to provide a light beam emitter with a simple structure which can direct a light beam toward any positions on the 2D coordinate system, and also to provide an image-forming device [using the light beam emitter of the present invention].

### SUMMARY OF THE INVENTION

To achieve the objective, the present invention features a light beam emitter having a light source device which is equipped with a light source and a light deflection mechanism which directs the light beam emitted by the light source device in any directions, wherein the light deflection mechanism has a light deflection member provided with a deflective surface which deflects the incident light beam toward different positions on the 2-D coordinate depending on the incident positions of the light beam and a drive mechanism which drives the light deflection member to change the incident positions of the light beam emitted by the light source device into the light deflection member.

In the present invention, as the light deflection member is driven by the drive mechanism, the incident position of the light beam on the light deflection member is changed; therefore, the light beam exits from the light deflection member toward different positions on the 2D coordinate system. For this reason, a light beam is directed to the predetermined positions on the 2-D coordinate system without a drive mechanism to scan in the secondary scanning direction.

In the present invention, the light deflection member is a light deflection disk equipped with a deflective disk surface as the deflective surface, and the drive mechanism is a rotary drive mechanism that rotates the light deflection disk to change the incident position of the light beam emitted by the light source device into the light deflection member. With this configuration, the light deflection disk rotates within the space in which the disk is arranged. Therefore, only a small space is required around the light deflection member. Also, when the light beam needs to be repeatedly emitted, the light deflection disk only needs to be kept rotating. This results in simplifying the device.

In the present invention, it is preferred that the light deflection disk be a transmissive light deflection disk which a light beam enters, passes through, and exits from in different directions depending on the incident position of the beam. With this configuration, a refraction action is used, in which the angle of refraction will not be affected by the wavelength of the incident light beam or temperature change. Also, the transmissive light deflection disk may suffer rotation vibrations or surface vibrations, but the angle of refraction will hardly be changed. Further, the transmissive light deflection disk may experience temperature change, but the change in transmissivity which may be caused by temperature change is very small compared to the change in diffraction efficiency. Therefore, a light beam of stable intensity can be directed in any directions with little influence by temperature change.

In the present invention, it is preferred that the light deflection disk be formed with an anti-reflection film over at least one of the disk surfaces. This construction can minimize the loss of amount of light (light intensity).

In the present invention, it is preferred that the light deflection disk surface be formed with an inclined surface that is inclined in at least one of the directions, the radial and/or circumferential directions, to refract the incident light beam in a predetermined direction. With this construction, there is no need to form a more complicated refraction surface.

In the present invention, it is preferred that only one side of the light deflection disk be formed as the light deflective disk surface. With this construction, a light deflection disk can be efficiently manufactured, contributing to manufacturing an inexpensive light deflection disk.

In the present invention, the inclined surface is formed so as to satisfy the relation,
sin(θw+θs)=n·sin θw
where θw is the angle of inclination which the inclined surface makes with the deflective disk surface, θs is the angle which the light beam makes with the normal of the deflective disk surface as it exits from the transmissive light deflection disk, and n is the index of refraction of the transmissive light deflection disk.

In the present invention, the inclined surface is formed at a different angle in each of a plurality of light deflection areas which are divided along the circumferential direction.

In the present invention, it is preferred that the angle of inclination of the inclined surface be increased or decreased in the plurality of light deflection areas along the circumferential direction.

In the present invention, the inclined surface may be formed as a continuous surface, in which the angle of inclination changes continuously in the circumferential direction. With this construction, the resolution can be improved.

In the present invention, a construction may be used in which the light deflection disk has a track thereon that can direct the incident light beam in different directions depending on the incident positions of the light beam.

In the present invention, a construction may be used in which the light source device is provided as single to irradiate a light beam onto one place of said track in the circumferential direction.

Another construction may be used in which the light source device is provided in multiple in order to irradiate a light beam onto each of a plurality of places on the track in the circumferential direction.

Also, another construction may be used in which the light source device is provided as single and equipped with an optical path splitter that splits the beam emitted by the light source toward each of the plurality of places on the track in the circumferential direction so that a light beam is irradiated onto each of the plurality of places on the track in the circumferential direction.

Further, another construction may be used in which the light source device is provided as single and a light source drive mechanism is provided for rotating the light source device or driving it in a straight line so that a light beam is irradiated onto each of a plurality of places on the track in the circumferential direction.

In the present invention, it is preferred that the light deflection disk have a plurality of tracks that are formed concentrically and can direct the incident light beam toward different positions depending on the incident positions of the beam, and the light source device is provided as multiple in order to irradiate the light beam to each of the plurality of tracks. With this construction, only a single light deflection disk is needed to direct the light beam in multiple directions.

Also, a construction may be used in which the light deflection disk has a plurality of tracks that are formed concentrically and can direct the incident light beam toward different positions depending on the incident positions of the beam, and the light source device is provided as single and equipped with an optical path splitter that splits the beam emitted by the light source toward each of the plurality of places on the track in the circumferential direction so that a light beam is irradiated onto each of the plurality of places on the track in the circumferential direction.

Further, another construction may be used in which the light deflection disk has a plurality of tracks that are formed concentrically and can direct the incident light beam toward different positions depending on the incident positions of the beam, and the light source device is provided as single and a light source drive mechanism is provided for rotating the light source device or driving it in a straight line so that a light beam is irradiated onto each of the plurality of places on the track in the circumferential direction.

In the present invention, a construction may be used in which the deflective disk surface is formed corresponding to the pattern by which the light deflection disk deflects the light beam (the exiting pattern of the beam). In other words, if an image to be formed is predetermined, the deflective disk surface can be formed according to the predetermined image.

In the present invention, another construction may be used in which the deflective disk surface is formed so as to direct the incident light beam toward each position arranged in a matrix pattern, and the light source device emits the light beam at the timing corresponding to the exiting pattern of the light beam so that the light beam selectively enters predetermined positions on the deflective disk surface. With this construction, by simply changing the timing at which the light source device emits the light beam, images of different forms can be expressed.

In the present invention, it is preferred that the light source device have the said light source and a collimating lens that guides the light beam emitted by the light source onto the deflective disk surface as a collimated beam. With this construction, a light beam of stable intensity can be directed in any directions despite the distance between the light source device and the light deflection disk and the distance between the light deflection disk and a surface to be irradiated by the light beam.

In the present invention, the light source device has the said light source and a condensing lens that guides the light beam emitted by the light source onto the deflective disk surface as a converged beam in the perpendicular direction, in the horizontal direction, or in both the perpendicular and horizontal directions of the beam emitted by the light source. In this case, it is preferred that the converged beam focus on or in the vicinity of the deflective disk surface in the perpendicular direction, in the horizontal direction, or in both perpendicular and horizontal directions of the light beam emitted by the light source.

In the present invention, it is preferred that light beam have a beam size of 3 mm or less on the deflection disk in the circumferential direction. This construction contributes to the improvement of resolution. Also, when the same level of resolution is used, the deflection disk can be manufactured small.

In the present invention, it is preferred that light beam have a beam size of 3 mm or less on the deflective disk surface in the circumferential and radial directions. This construction contributes to the improvement of resolution. Also, when the same level of resolution is used, the deflection disk can be manufactured small.

In the present invention, it is preferred that the light deflection disk be made of resin. This construction contributes to an inexpensive device with light weight.

In the present invention, it is preferred that a position detector be also provided to detect the position of rotation of the light deflection disk, and the rotation of the light deflection disk is controlled based on the result of the detection by the position detector.

A light beam emitter to which the present invention is applied is used in an image-forming device. In this case, a 2D image can be formed with the light beams emitted by the light deflection mechanism.

In the present invention, as the light deflection member is driven by the drive mechanism, the incident position of the light beam onto the light deflection member is changed; therefore, the light beam exits from the light deflection member toward different positions on the 2D coordinate system. In this manner, a light beam can be directed to the predetermined positions on the 2D coordinate system without providing a drive mechanism to scan in the secondary scanning direction.

### BRIEF DESCRIPTION OF DRAWING

FIG. 1 is a perspective view of a construction of a light beam emitter of Embodiment 1 of the present invention.

FIG. 2 is a perspective view schematically showing the construction of the light beam emitter illustrated in FIG. 1.

FIG. 3 is an explanatory diagram showing that light beam is deflected by a transmissive light deflection disk used in the light beam emitter of FIG. 1.

FIGS. 4(a) through (e) are respectively a plan view, D1-D1 cross section, D2-D2 cross section, D3-D3 cross section, and W-W cross section of the transmissive light deflection disk of FIG. 1.

FIG. 5(a) is an explanatory diagram showing that the beam is deflected in the Y and X directions by the transmissive light deflection disk used in the light beam emitter of FIG. 1 and 5(b) is an explanatory diagram showing that the beam is deflected in the Y direction.

FIG. 6(a) is an explanatory diagram of an image which is drawn by an image-forming device equipped with a light beam emitter to which the present invention is applied, and 6(b) is an explanatory diagram of a transmissive light deflection disk for drawing such an image.

FIG. 7(a) is an explanatory diagram of an image drawn by an image-forming device equipped with the light beam emitter to which the present invention is applied, and 7(b) is an explanatory diagram of a transmissive light deflection disk used for drawing such an image.

FIG. 8 is an explanatory diagram of a light beam emitter of Embodiment 4 of the present invention.

FIG. 9(a) and 9(b) are explanatory diagrams of a light beam emitter of one embodiment of the present invention.

FIG. 10 is an explanatory diagram of a light beam emitter of another embodiment of the present invention.

FIG. 11 is an explanatory diagram of a light beam emitter of yet another embodiment of the present invention and another transmissive light deflection disk used in the light beam emitter.

FIG. 12(a) and (b) are explanatory diagrams of a light beam emitter of yet another embodiment of the present invention.

FIG. 13 is an explanatory diagram of a light beam emitter of another embodiment of the present invention.

FIG. 14 is a descriptive drawing of another transmissive light deflection disk used in a light beam emitter of yet another embodiment of the present invention.

### DETAILED DESCRIPTION OF THE DRAWINGS

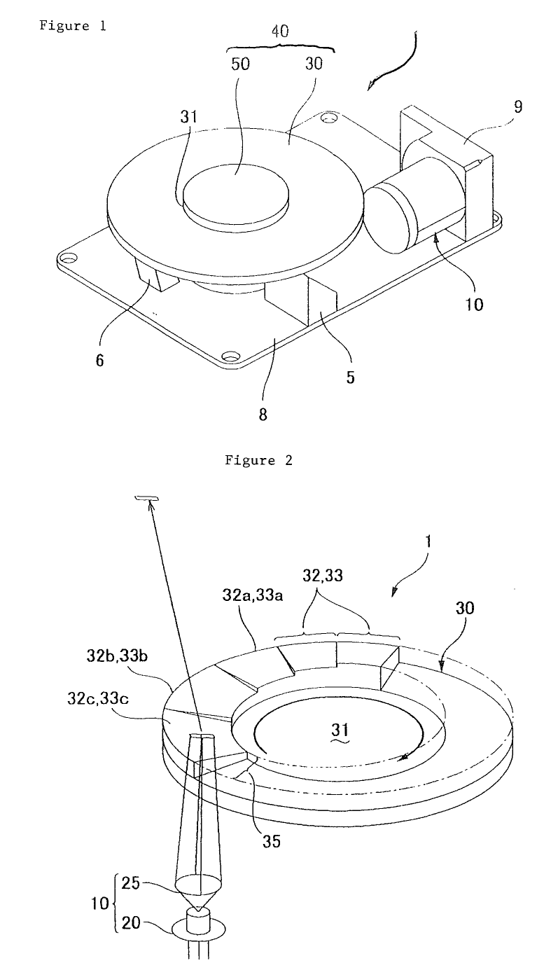

FIG. 1 is a perspective view of a construction of a light beam emitter of Embodiment 1 of the present invention. FIG. 2 is a perspective view schematically showing the construction of the light beam emitter illustrated in FIG. 1.

In FIG. 1, a light beam emitter of Embodiment 1 of the present invention has a light source device 10 and a light deflection mechanism 40 that deflects the light beam emitted by the light source device 10 in predetermined directions with a transmissive light deflection disk 30 as a light deflection member.

The light deflection mechanism 40 has the transmissive light deflection disk 30 (light deflection member) and a rotation drive mechanism (drive mechanism) equipped with a motor 50 which rotates the transmissive light deflection disk 30 around the axis. The motor 50 is a brushless motor which rotates at high speed, such as at 10000 (rpm). The transmissive light deflection disk 30 is fixed to a rotor of the drive motor 50 with the center opening 31 thereof, and can be rotated about the axis (the center of the transmissive light deflection disk 30) of the drive motor 50. The drive motor 50 is not limited to a brushless motor, but various kinds of motor such as a stepping motor can be used.

The light beam emitter 1 is equipped with a mirror 5 which bends the light beam emitted by the light source device 10 upright toward the transmissive light deflection disk 30 and an optical encoder 6 which is a position detector for detecting the position of rotation of the transmissive light deflection disk 30. The light source device 10 emits a light beam in the direction parallel to the disk surface of the transmissive light deflection disk 30. The mirror 5 is a total reflection mirror, which is arranged to bend the light beam emitted by the light source device 10 in the axial direction of the drive motor 50 so that the beam enters the disk surface of the transmissive light deflection disk 30 from the direction perpendicular to the disk surface. The drive motor 50, the mirror 5 and the optical encoder 6 are arranged directly on frame 8, and the light source device 10 is arranged on the frame 8 via a holder 9.

The optical encoder 6 is arranged to face the transmissive light deflection disk 30 in the axial direction of the drive motor 50. A grating (not illustrated) is formed on the surface of the transmissive light deflection disk 30 which faces the optical encoder 6; as the optical encoder 6 detects the grating, the position of rotation of the transmissive light deflection disk 30 is detected. In the light beam emitter 1 of this embodiment, the rotation of the drive motor 50 and the light emission of the light source of the light source device 10 are controlled based on the detection results by the optical encoder 6. Note that a photo coupler or magnetic sensor may be used in place of the optical encoder 6 for detecting the angle position of the transmissive light deflection disk 30. Also, the mirror 5 may be omitted and the light beam emitted by the light source device 10 may be directly guided to the transmissive light deflection disk 30.

The light beam emitter 1 constructed as above is illustrated in FIG. 2. As shown in FIG. 2, the light source device 10 is equipped with a light source 20 composed of a laser diode and a collimating lens 25 which guides the light beam emitted by the light source 20 to the transmissive light deflection disk 30 as a collimated beam. Note that the light source device 10 also has a drawing member (not illustrated).

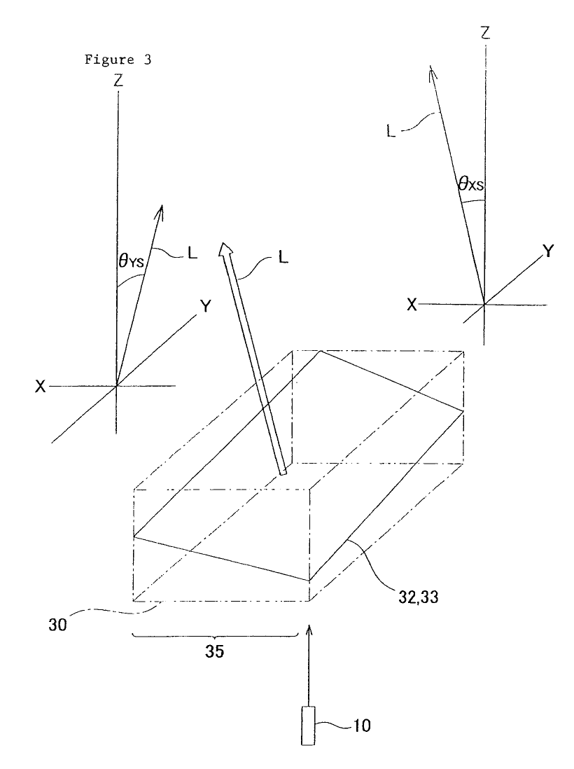

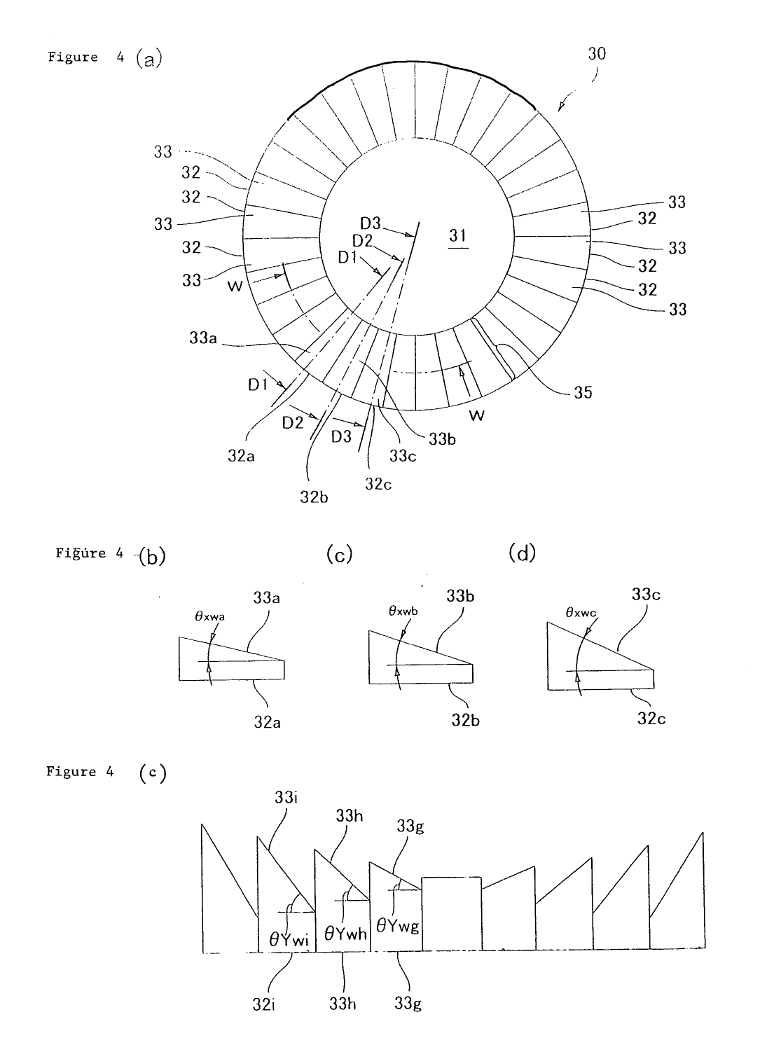

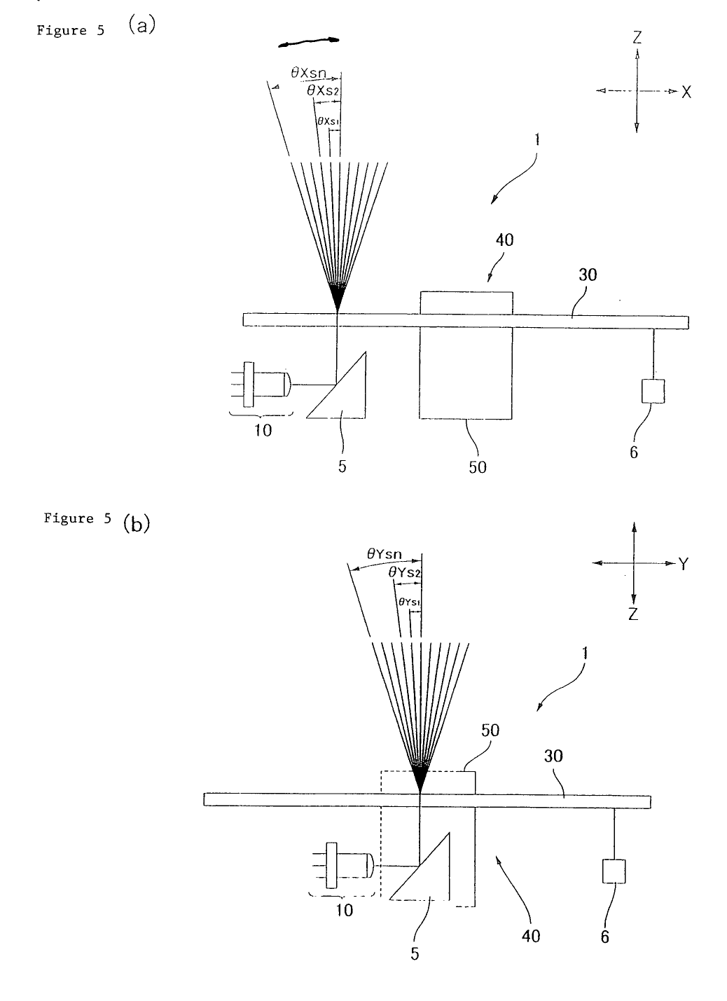

FIG. 3 is an explanatory diagram to show that the beam is deflected by the transmissive light deflection disk used in the light beam emitter of FIG. 1. FIGS. 4(a) through (e) are respectively a plan view, D1-D1 cross section, D2-D2 cross section, D3-D3 cross section, and W-W cross section of the light deflection disk of FIG. 1. FIG. 5(a) is an explanatory diagram to show that the beam is deflected in the Y and X directions by the transmissive light deflection disk used in the light beam emitter of FIG. 1 and (b) is an explanatory diagram to show that the beam is deflected in the Y direction.

As illustrated in FIG. 2, the transmissive light deflection disk 30 has a track 35 thereon in which the disk surface is divided into a plurality of radial light deflection areas 32. In the track 35, each of the light deflection areas 32 has an inclined surface 33 which inclines at a constant angle.

As illustrated in FIG. 3, each of the light deflection areas 32 is able to direct the light beam L toward different positions on the 2D coordinate system (XY coordinate system). The inclined surface 33 is formed only on the disk surface of the transmissive light deflection 30 on the beam-exiting side, which functions as a deflective disk surface. This will be described in detail later.

As illustrated in FIG. 4(a), such a transmissive light deflection disk 30 is constructed such that a plurality of light deflection areas 32 on the deflective disk surface (top surface) of the transmissive light deflection disk 30 include the area having the inclined surface in the radial direction only, the area having the inclined surface 33 in the circumferential direction only, and the area having the inclined surface 33 in both radial and circumferential directions. A plurality of inclined surfaces 33 also includes the area having the angle of inclination of 0°.

In other words, the D1-D1 cross section, D2-D2 cross section, D3-D3 cross section of the transmissive light deflection disk 30 are respectively shown in FIGS. 4(b), (c), and (d) in which the inclined surface 33 is inclined in the radial direction in each of the light deflection areas, and the cross section of each light deflection area 32 is wedge-shaped. Therefore, the cross section of each light deflection area 32 in the radial direction is of a trapezoid shape in which the inner circumferential edge and outer circumferential edge are parallel to each other. In the light deflection areas 32 arranged along the circumferential direction, the angle of inclination of the inclined surface 33 is increased or decreased.

At the transmissive light deflection disk 30 constructed as above, when the beam that has entered from the disk surface on the bottom side passes through the transmissive light deflection disk 30 and exits as the light beam L from the disk surface on the top side, it is refracted at the inclined surface 33 of the light deflection area 32 in the X direction as illustrated in FIG. 3 and FIG. 5(a). Since the transmissive light deflection disk 30 is rotated by the drive motor 50, the incident position of the beam into the transmissive light deflection disk 30 is shifted in the circumferential direction. Also, in each light deflection area 32, the angle of inclination of the inclined surface 33 in the radial direction differs depending on the area 32. For this reason, the beam that has entered into the transmissive light deflection disk 30 changes its exiting direction in the X direction depending on which light deflection area 32 it exits from. In other words, the inclined surface 33 is formed so as to satisfy the relation,
sin(θxw+θxs)=n·sin θxw
where θxw is the angle of inclination of the inclined surface 33 which is made when a predetermined position of the inclined surface 33 and the exiting beam are projected to the XZ plane, θxs is the scanning angle of the light beam as the beam exits from the transmissive light deflection disk 30, and n is an index of refraction of the transmissive light deflection disk 30. Therefore, the beam that has entered the transmissive light deflection disk 30 is directed in the predetermined directions in the X direction when projected onto the XZ plane.

Also, the W-W cross section of the transmissive light deflection disk 30 is shown in FIG. 4(e). As illustrated, the inclined surface 33 is inclined in the circumferential direction in each of a plurality of light deflection areas 32, and the cross section of each light deflection area 32 is wedge-shaped. Therefore, the cross section of each light deflection area 32 in the circumferential direction is in a trapezoid shape in which the borders between the adjacent light deflection areas are parallel. In each of the light deflection areas 32, the angle of inclination of the inclined surface 33 is increased or decreased toward the circumferential direction.

For the transmissive light deflection disk 30 constructed as above, when the beam that has entered the disk surface from the bottom side passes through the transmissive light deflection disk 30 and exits the disk surface from the top side, it is refracted at the inclined surface 33 of the light deflection area 32 in the Y direction, as illustrated in FIG. 3 and FIG. 5 (b). Since the transmissive light deflection disk 30 is rotated by the drive motor 50, the incident position of the beam into the transmissive light deflection disk 30 is shifted in the circumferential direction. Also, in each light deflection area 32, the angle of inclination of the inclined surface 33 in the circumferential direction differs depending on the area 32. For this reason, the beam that has entered into the transmissive light deflection disk 30 changes its exiting direction in the Y direction depending on which light deflection area 32 it exits from. In other words, the inclined surface 33 is formed so as to satisfy the relation,
sin(θyw+θys)=n·sin θyw
where θyw is the angle of inclination of the inclined surface 33 which is made when a predetermined position of the inclined surface 33 and the exiting beam are projected to the YZ plane, θys is the scanning angle of the light beam as the beam exits from the transmissive light deflection disk 30, and n is an index of refraction of the transmissive light deflection disk 30. Therefore, the beam that has entered the transmissive light deflection disk 30 is emitted in the predetermined directions in the Y direction when projected onto the YZ plane.

For these reasons, the light deflection areas 32 deflect the beam toward different positions on the 2D coordinate system (XY coordinate system).

At that time, it is preferred that the light beam enter the center position of a single light deflection area 32 in the radial direction. It is also preferred that the size of the beam on the light deflection area 32 in the circumferential direction be 3 mm or less, and it is further preferred that the sizes of the beam in both circumferential and radial directions be 3 mm or less. Also, it is preferred that an anti-reflection treatment such as a thin film or a fine structure be provided on the disk surface of the transmissive light deflection disk 30. This treatment can greatly reduce the returning beam to the laser which causes the laser to have non-uniform output and the loss of amount of light (light intensity).

The transmissive light deflection disk 30 constructed as above may be manufactured directly through a super precision process of cutting transparent resin, or it may even be preferred to manufacture the disk 30 using a mold in order to reduce cost. When manufacturing the transmissive light deflection disk 30 or a mold through a cutting process, the front tip of the blade used in the cutting process is moved in the radial direction of the disk 30 to form an inclined surface 33, and then by changing the inclination of the blade tip and rotating the transmissive light deflection disk 30 at a predetermined angle in the circumferential direction, the inclined surface 33 of the adjacent light deflection area 32 can be formed. In other words, used is a method in which a disk is first rotated, a cutting tool is moved in the radial direction and [the surface] is cut, the disk is again rotated and [the surface] is cut in the radial direction; this procedure is repeated. At that time, the angle of rotation of the disk is equivalent to ⅓ or less of the diameter of the incident beam. By using such a processing method, a geometrically-impossible surface shape can be easily formed very closely [to the ideal shape] (within the margin of error with respect to the beam). Since it is to process a plane, a mold can be easily made, compared to a conventional polygonal mirror, and distortion and shrinkage cavities will not easily be caused during forming. Thus, it is relatively easy.

In this embodiment, only one side of the transmissive light deflection disk 30 is constructed as a deflective disk surface; therefore, a piece processing needs to be performed only on one side of the disk, and so a mold can be easily formed. Also, even when a device material itself is processed, only one side of the disk needs to be processed, facilitating fixing during the process.

In either case, when the transmissive light deflection disk 30 is made of resin, it can be made inexpensively with light weight. Even when the transmissive light deflection disk 30 is made of resin, temperature change about ±50° C. with respect to room temperature does not affect the disk and the change in the exiting angle of the beam is kept to only 1% or less, considering (the influence) of change in wavelength and change in the index of refraction. Also, since it is to process a plane, a mold can be easily made compared to a polygonal mirror, and distortion and shrinkage cavities will not easily be caused during forming. Thus, it is relatively easy. Further, since a cutting process of a mold or a material uses a fly cut or shaper cut in which a blade is moved in a direction on the inclined surface, a precise angle and surface roughness can be obtained on NC data. When the cross section of the disk in the circumferential direction is wedge-shaped, the wedge shape is determined by the angle of inclination of the blade and a surface roughness is determined by precision of the blade. Therefore, if a cutting tool having a blade of high precision is used, a highly precise process can be performed.

Note that when the transmissive light deflection disk 30 is formed of glass, stable performance can be obtained despite a temperature change of ±50° or more or high temperature.

In either case, in the transmissive light deflection disk 30 a linear expansion caused by temperature change is a radial expansion, which does not affect the angle of inclination very much.

As described above, in the light beam emitter 1 of this embodiment, while the transmissive light deflection disk 30 is being rotated, the light beam emitted by the light source device 10 enters the transmissive light deflection disk 30. As a result, as the light beam first enters a predetermined position on the transmissive light deflection disk 30 in the circumferential direction, passes through and exits the disk 30 from the disk surface on the top side, the light beam exits in the direction which corresponds to the angle of inclination of the inclined surface 33 of the light deflection area 32. A plurality of light deflection areas 32 are composed of the area in which the inclined surface 33 is inclined only in the radial direction, the area in which the inclined surface 33 is inclined only in the circumferential direction, the area in which the inclined surface 33 is inclined in both radial and circumferential directions, and the area in which the angle of inclination is 0°. Therefore, each of the light deflection areas 32 deflects the light beam toward different positions on the 2D coordinate system (XY coordinate system). For this reason, in the light beam emitter 1 of this embodiment, there is no need to provide a special mechanism for directing a light beam in the main scanning direction and secondary scanning direction, and a light beam can be deflected to predetermined positions on the 2D coordinate system.

Also, in the light beam emitter 1 of this embodiment, since the transmissive light deflection disk 30 is of a flat, disk shape, the device can be made thin. Further, since it is constructed such that the light beam emitted by the light source device 10 passes through the transmissive light deflection disk 30, the angle of refraction remains almost the same even if rotational vibration is caused to the transmissive light deflection disk 30 which is rotated by the drive motor 50. Therefore, the scanning jitter of the light beam is good. Furthermore, since the transmissive light deflection disk 30 is formed of resin, productivity of the transmissive light deflection disk 30 is high and the light beam emitter 1 can be manufactured with light weight at low cost. Moreover, even when a temperature change of ±50°, for example, occurs, the scanning angle may vary by only 1% or less, and thus the scanning performance is not affected very much.

Also, because the transmissive light deflection disk 30 needs to be only rotated, durability is high, power consumption is low and heat generation by the rotating mechanism is very small, compared to a repeating motion such as a mirror drive method or a lens drive method.

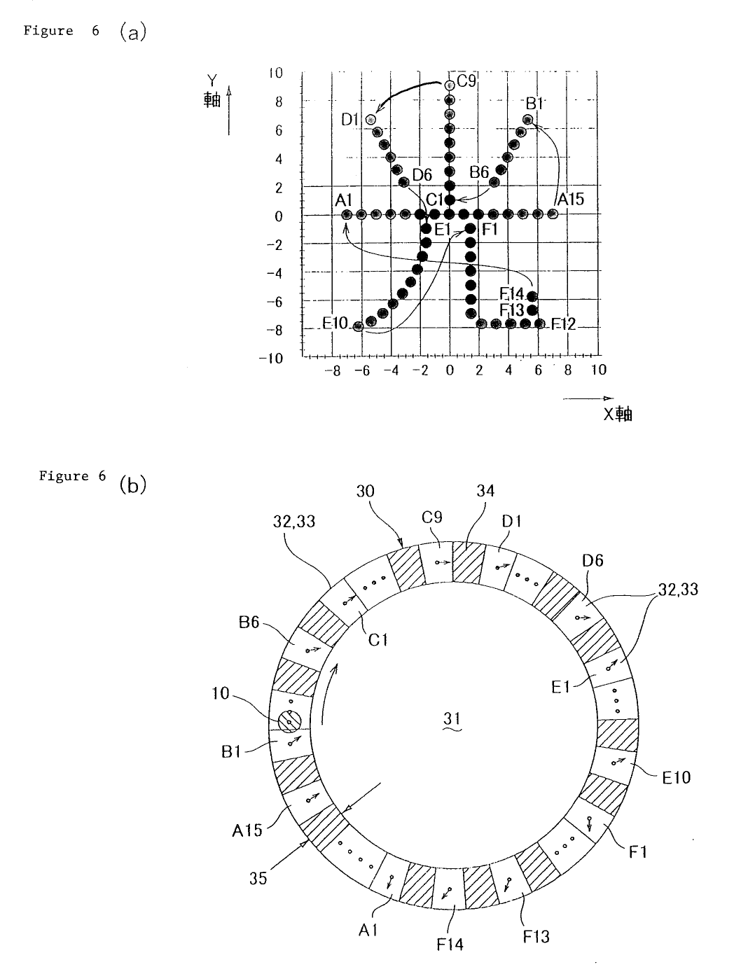

FIG. 6(a) is an explanatory diagram of an image which is drawn by an image-forming device equipped with a light beam emitter to which the present invention is applied, and FIG. 6(b) is an explanatory diagram of a transmissive light deflection disk for drawing such an image. Note that the basic construction of a beam emitter used in an image-forming device of this embodiment is the same as one described in Embodiment 1; therefore, the common portions are given the same codes and their descriptions are omitted.

As shown in FIG. 6(a), an image-forming device of this embodiment is to direct a light beam in the shape of the Chinese character “hikari” (meaning “light”), for example, on a plane expressed by the XY coordinate system; as shown in FIG. 6(b), the transmissive light deflection disk 30 that is described in Embodiment 1 is used [in the image-forming device]. On the deflective disk surface of the transmissive light deflection disk 30, a track 35 is formed in which a plurality of light deflection areas 32 is arranged in the circumferential direction. Between the adjacent photodeflective areas 32, a mask area 34 that is non-transmissive or has light scattering characteristic is formed; in FIG. 6(b) the mask area 34 is shaded by oblique lines upward to the right. Also, the position on the transmissive light deflection disk 30 into which the light beam enters is marked by a circle L10 shaded by oblique lines downward to the right.

In such an image-forming device, the Chinese character, “hikari” shown in FIG. 6(a) is composed of many dots arranged on the XY coordinate system; for example, the coordinates of the dots A1, C9, B1 are expressed by (−7, 0), (0, 9), (5.5, 6.7). The lines connecting the dots indicate the order in which the light beam is focused.

In order to form such a character image on a surface such as a screen, an inclined surface is formed in each light deflection area 32 of the transmissive light deflection disk 30 for guiding the light beam to the predetermined positions on the XY coordinate system in which the original point is the incident position of the light beam marked by a circle L 10. In FIG. 6(b), the arrow given to each of the light deflection areas 32 indicates the direction in which each light deflection area 32 directs the beam when each light deflection area 32 reaches the incident position of the light beam emitted by the light source device 10, which is marked by a circle L10. Although the image is a drawing by an arrangement of dots (dot line), a drawing by smooth lines can be done by making the width of the inclined surface in the circumferential direction smaller.

In the image-forming device constructed as above, a track 35 which has a pattern corresponding to the exiting pattern of the light beam is formed on the deflective disk surface of the transmissive light deflection disk 30. Therefore, with the transmissive light deflection disk 30 rotated, the beam emitted by the light source device 10 first enters a predetermined position on the transmissive light deflection disk 30 in the circumferential direction, passes through the disk and then exits from the disk surface on the top side. The light beam exits in the direction corresponding to the angle of inclination of the inclined surface 33 of the light deflection area 32. A plurality of light deflection areas 32 are composed of the area in which the inclined surface 33 is inclined only in the radial direction, the area in which the inclined surface 33 is inclined only in the circumferential direction, the area in which the inclined surface 33 is inclined in both radial and circumferential directions, and the area in which the angle of inclination is 0°; therefore, a plurality of light deflection areas 32 respectively deflects the beam toward different positions on the 2D coordinate system (XY coordinate system). For this reason, in the light beam emitter 1 of this embodiment, there is no need to provide a special mechanism to direct the light beam in the main scanning direction and in the secondary scanning direction, and the light beam can be directed toward the predetermined positions on the 2D coordinate system and the image of the Chinese character “hikari” can be formed. Thus, this [image] can be used for circulation, advertisement, demonstration, or illumination.

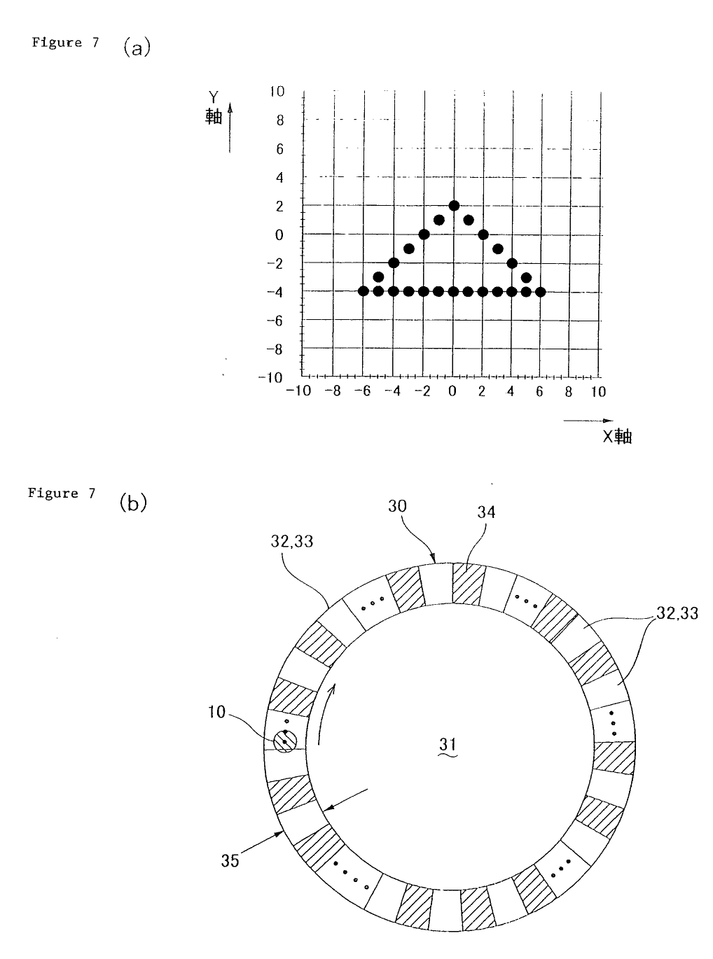

FIG. 7(a) is an explanatory diagram of an image drawn by an image-forming device equipped with the light beam emitter to which the present invention is applied, and (b) is an explanatory diagram of a transmissive light deflection disk for drawing such an image. Note that the basic construction of the beam emitter used in an image-forming device of this embodiment is the same as those of Embodiments 1 and 2; therefore, the common portions are given the same codes and their descriptions are omitted.

In FIG. 7(a), an image-forming device of this embodiment is to direct a light beam onto a surface to be irradiated (plane) such as a screen, which is expressed by the 2D coordinate system, in the shape of the symbol “Δ”, for example; as illustrated in FIG. 7(b), the transmissive light deflection disk 30 described in Embodiment 1 is used. On the deflective disk surface of the transmissive light deflection disk 30, a track 35 is formed in which a plurality of light deflection areas 32 are arranged in the circumferential direction. Between the adjacent light deflection areas 32, a mask area 34 is formed which is non-transmissive and has light scattering characteristic. In FIG. 7(b), the mask area 34 is shaded by oblique lines upward to the right. Also, in the transmissive light deflection disk 30, the incident position of the light beam emitted by the light source device 10 is marked by a circle L10 shaded by oblique lines downward to the right.

In such an image-forming device, an inclined surface 33 is formed in each of the light deflection areas 32 of the transmissive light deflection disk 30 for deflecting the light beam to any of the matrix-like positions (coordinate position (x, y)), which is expressed by the XY coordinate system having the incident position of the light beam marked by the circle L10 as an original point. In other words, in each light deflection area 32 of the transmissive light deflection disk 30, an inclined surface 33 that can direct the light beam toward positions of the coordinates (−10, −10), (−10, −9), . . . (0, 0), . . . (10, 10) is formed.

In the image-forming device constructed as above, with the transmissive light deflection disk 30 rotated, the light source 10 emits light beam toward the transmissive light deflection disk 30 at a predetermined timing under the control by a control device (not illustrated). Consequently, as the light beam first selectively enters a predetermined position on the transmissive light deflection disk 30 in the circumferential direction, passes through the disk and exits from the disk surface on the top side, the light beam exits in the direction corresponding to the angle of inclination of the inclined surface 33 of the light deflection area 32. A plurality of light deflection areas 32 are composed of the area in which the inclined surface 33 is inclined only in the radial direction, the area in which the inclined surface 33 is inclined only in the circumferential direction, the area in which the inclined surface 33 is inclined in both radial and circumferential directions, and the area in which the angle of inclination is 0°; therefore, a plurality of light deflection areas 32 deflect the beam toward the different positions on the 2D coordinate system (XY coordinate system). For this reason, in the light beam emitter 1 of this embodiment, there is no need to provide a special mechanism to direct the light beam in the main scanning direction and in the secondary scanning direction, and the light beam can be deflected toward predetermined positions on the 2D coordinate system.

Further, by changing the timing for emitting the light beam toward the transmissive light deflection disk 30 from the light source device 10, another image can be expressed in place of the symbol “Δ”.

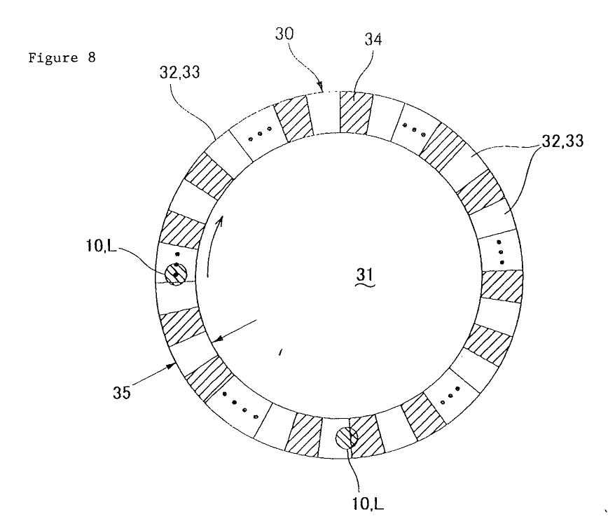

FIG. 8 is an explanatory diagram of a light beam emitter of Embodiment 4 of the present invention. While the transmissive light deflection disk 30 in the above described embodiments has a single track 35 that can direct the incident light beam toward different positions depending on the incident positions of the beam and a single light source device 10 is provided, the light source device 10 may be arranged at two or more different positions in the circumferential direction, as illustrated by the circles L shaded by oblique lines upward to the right in FIG. 8.

With such a construction, the position of an image can be shifted on the XY coordinate system depending on which light source device 10 is used. Also, an image can be formed by a plurality of light beams deflected from the transmissive light deflection disk 30 when the angle and direction of inclination of the inclined surface 33 formed in the light deflection area 32 are agreed with the position of the light source device 10 and the rotation of the transmissive light deflection disk 30 is synchronized with the timing of emitting the light beam from each of the light source devices 10.

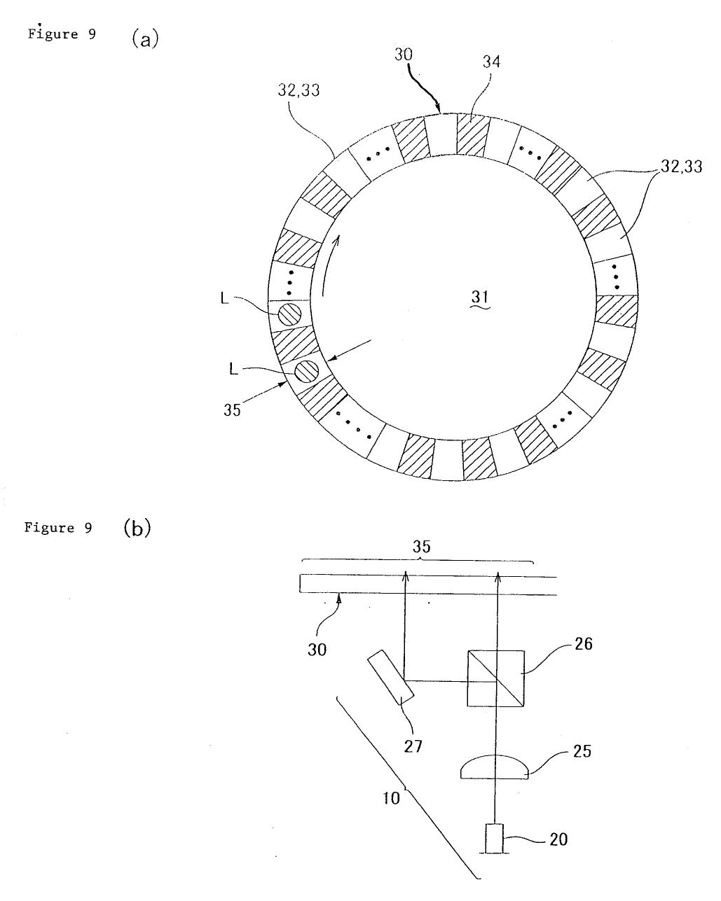

FIGS. 9(a) and (b) are explanatory drawings of a light beam emitter of Embodiment 5 of the present invention. As schematically shown by circles L shaded by oblique lines downward to the right in FIGS. 9(a) and (b), in order to have the light beam L enter different positions on the transmissive light deflection disk 30 in the circumferential direction, the light beam may be emitted by one light source device 10, for example, onto two positions on the track 35 in the circumferential direction. In this case, the light source 10 is provided with an optical path splitter 26 that splits the incident beam from a light source 25 into two light beams and a total reflective mirror 27 that reflects one of the two beams, which have been split by the optical path splitter 26, toward a predetermined position on the track 35. With this construction, the light beams exit from two light deflection areas 32 simultaneously; therefore, one image can be expressed by synthesizing these two light beams.

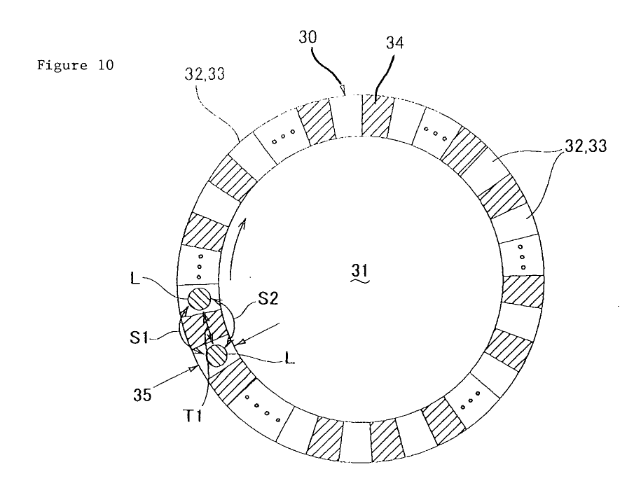

FIG. 10 shows an explanatory diagram of a light beam emitter of Embodiment 6 of the present invention. In order to have the light beam L enter different positions on the transmissive light deflection disk 30 in the circumferential direction, a light source drive mechanism for rotating the light source device 10 (indicated by arrow S1 or S2) or a light source drive mechanism for driving the light source device 10 in a straight line (indicated by arrow T1) may be provided as schematically illustrated by circles L shaded by oblique lines downward to the right in FIG. 10, so that the single light source device 10 emits the light beam to two positions on the track 35 in the circumferential direction.

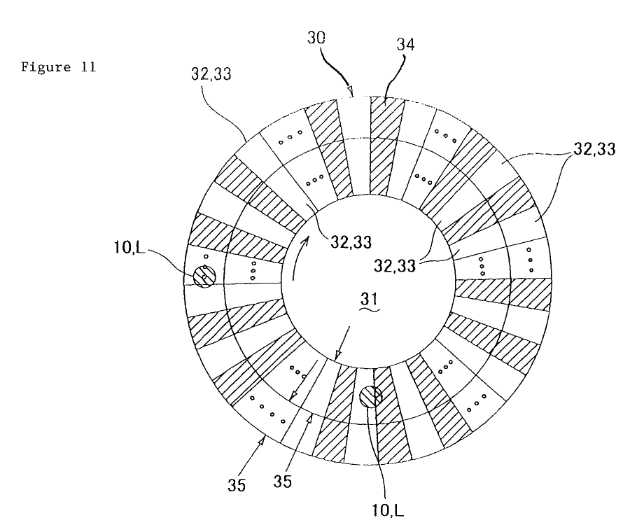

FIG. 11 is an explanatory drawing of a light beam emitter of Embodiment 7 of the present invention and another transmissive light deflection disk used in the light beam emitter. In the above embodiments, the transmissive light deflection disk 30 has one track 35 that can direct the incident light beam toward different directions according to the incident positions of the beam and one light source device 10 is provided; however, as illustrated in FIG. 11, a track 35 which can direct the incident light beam toward different positions depending to the incident positions of the beam may be formed in multiple concentrically on the transmissive light deflection disk 30, and the light source device 10 may be provided in multiple so that a light beam can be irradiated onto each of the plurality of tracks 35 as schematically illustrated by circles shaded by oblique lines downward to the right. With this construction, an image can be formed by synthesizing light beams guided by the plurality of tracks 35, and also multiple images can be formed at different positions on the XY coordinate system.

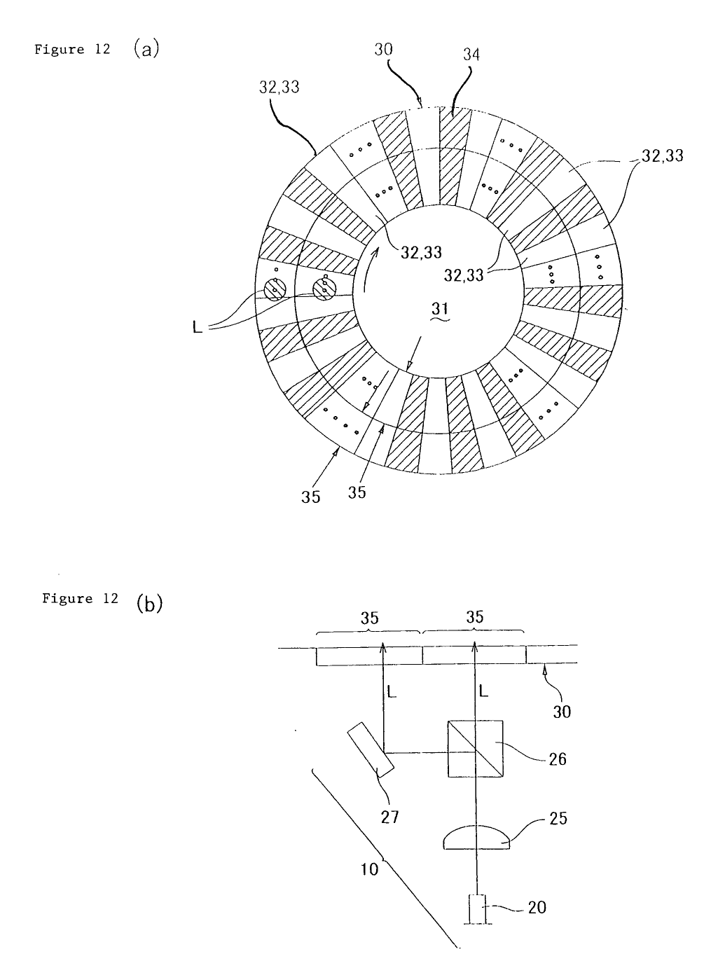

FIGS. 12(a) and (b) are drawings of a light beam emitter of Embodiment 8 of the present invention. As schematically illustrated by circles L shaded by oblique lines downward to the right in FIGS. 12(a) and (b), in order to have a light beam L enter each of a plurality of tracks 35 on the transmissive light deflection disk, a light beam may be irradiated by a single light source device 10, for example, on each of the two tracks 35. In this case, the light source device 10 may be provided with an optical path splitter 26 that splits the beam emitted by a light source 25 into two light beams and a total reflective mirror 27 that reflects one of the two beams, which have been split by the optical path splitter 26, toward one of the tracks 35. With this construction, the light beams exit from two light deflection areas 32 simultaneously; therefore, one image can be expressed by synthesizing these two light beams.

FIG. 13 shows an explanatory diagram of a light beam emitter of Embodiment 9 of the present invention. In order to have a light beam L enter each of two tracks 35 of the transmissive light deflection disk 30, a light source drive mechanism (indicated by arrow S3) for rotating the light source device 10 or a light source drive mechanism (indicated by arrow T2) for driving the light source device 10 in a straight line may be provided as schematically illustrated by circles L shaded by oblique lines downward to the right in FIG. 13, so that the single light source device 10 irradiates a light beam onto each of two tracks 35.

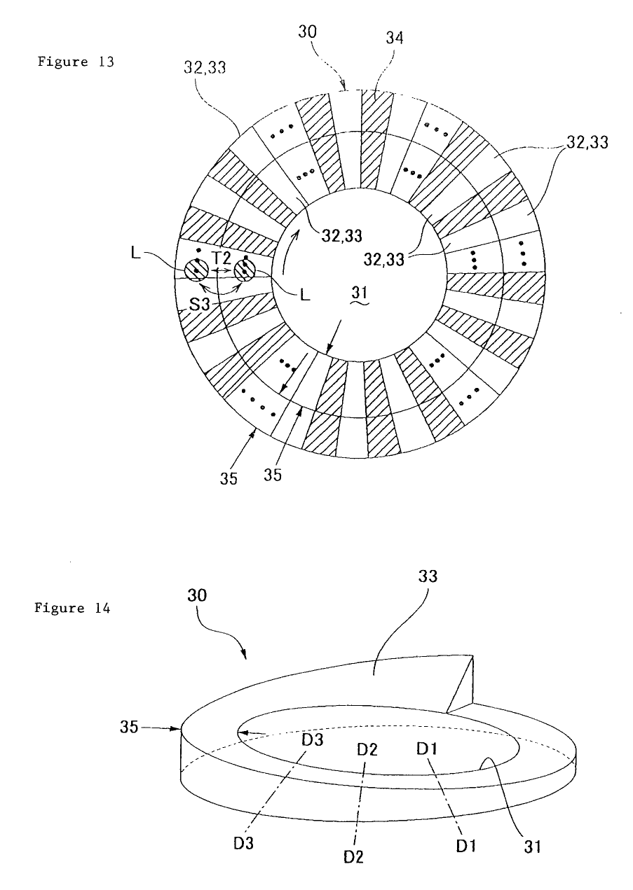

FIG. 14 is an explanatory diagram of another transmissive light deflection disk used in a light beam emitter of Embodiment 10 of the present invention. In the transmissive light deflection disk 30 of the above embodiments, a plurality of light deflection areas 32 are formed in the circumferential direction and the inclined surface 33 is formed in each of the light deflection areas 32; however, as illustrated in FIG. 14, the transmissive light deflection disk 30 of this embodiment has an inclined surface 33 continuously formed in the circumferential direction, in which the angle of inclination of the surface in the radial direction and the angle of inclination of the surface in the circumferential direction change continuously along the circumferential direction. When the transmissive light deflection disk 30 constructed as above is cut by the D1-D1 line, D2-D2 line, and D3-D3 line, the cross sections are shown as FIGS. 4(b), (c), (d) respectively. When such a transmissive light deflection disk 30 is used, the resolution can be infinitely high. Note that by using a processing method of cutting [the disk surface] in the radial direction, a geometrically-impossible surface shape can be formed very closely to ideal shape, that is, within the margin of error with respect to the beam.

Although the above mentioned embodiments are examples of suitable embodiments of the present invention, the present invention is not limited to these, but can be varyingly modified within the scope of the invention.

For example, the light source device 10 is equipped with the light source 20 and the collimating lens 25 that guides the light beam emitted by the light source 20 as a collimated beam to the deflective disk surface [in the above embodiment]; however, in place of the collimating lens 25, a condensing lens may be used for guiding the light beam emitted by the light source 20 as a converged beam in the perpendicular direction, in the horizontal direction, or in both perpendicular and horizontal directions of the light beam. In this case, it is preferred that the converged beam be focused on the deflective disk surface or in the vicinity of the deflective disk surface in the perpendicular direction, horizontal direction, or in both perpendicular and horizontal directions of the light beam emitted by the light source 20. This construction can minimize the light deflection area 32; therefore, more light deflection areas 32 can be formed on a single piece of transmissive light deflection disk 30. Also, by forming the same number of light deflection areas 32, a piece of transmissive light deflection disk 30 can be minimized. Even in this case, it is preferred that the size of the light beam in the circumferential direction be 3 mm or less, and it is also preferred that the beam size in both circumferential direction and radial direction be 3 mm or less.

For example, in the above embodiments, the inclined surface 33 is formed only on the beam-exiting side of the transmissive light deflection disk 30; however, it may be formed only on the beam-incident side of the disk 30. Further, the inclined surface 33 may be formed on both the beam-exiting side and beam-incident side of the disk 30. When the inclined surface is formed on both sides of the disk, the angle of inclination of the surface on the beam-incident side may be set the same for all the light deflection areas 32.

Also, in the above embodiments, the transmissive light deflection disk 30 is formed of resin; however, it may be formed of glass. In this case, since temperature change does not affect the disk 30, the temperature property is stabilized, enabling the light beam emitter to be used under high temperature environment.

Further, the position detecting mean may not be provided. As in the embodiment described above, when the transmissive light deflection disk 30 is formed with a plurality of light deflection areas 32 which are divided at equal distance along the circumferential direction, the motor 50 is controlled to rotate at constant speed and the pulse-like light beam is emitted by the light source device 10 at a constant interval in order to perform a proper scanning by the light beam.

Also, the mirror 5 may not be provided and the light beam be emitted by the light source device 10 toward the disk surface of the transmissive light deflection disk 30 so that the beam directly enters the transmissive light deflection disk 30. When the mirror 5 is used, the light source device can be arranged diagonally below the transmissive light deflection disk 30 so that a light beam enters the transmissive light deflection disk 30 diagonally from the bottom side of the disk 30.

Further, the device in the above embodiments is constructed such that the light beam emitted by the light source device 10 passes through the transmissive light deflection disk 30; however, it may be constructed such that the light beam emitted by the light source device 10 is reflected on the reflective light deflection disk. In this case, one in which the top surface or bottom surface of the light deflection disk 30 is formed as a reflective surface may be used as described referring to FIG. 4, for example.

Furthermore, in the above embodiment, the disk-like transmissive light deflection disk 30 is rotated; however, a light deflection member equipped with a deflective surface, which can deflect the incident beam toward different positions on the 2D coordinate system depending on the incident positions of the beam, is driven in a straight line by a drive mechanism in order to shift the incident position of the light beam emitted by the light source device into the light deflection member.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A light beam emitter having a light source device which is equipped with a light source and a light deflection mechanism which directs a light beam emitted by said light source device in any direction,
wherein said light deflection mechanism has a light deflection member provided with a deflective surface which deflects the incident light beam toward different positions on the 2D coordinate system depending on the incident positions of the light beam and a drive mechanism which drives said light deflection member to change the incident positions of the light beam emitted by said light source device into said light deflection member.

2. The light beam emitter of claim 1, wherein said light deflection member is a light deflection disk having with a deflective disk surface as said deflective surface, and
said drive mechanism is a rotation drive mechanism that rotates said light deflection disk to change the incident positions of the light beam emitted by said light source device into said light deflection member.

3. The light beam emitter of claim 2, wherein said light deflection disk is a transmissive light deflection disk which the light beam enters, passes through and exits from in different directions depending on the incident positions of the beam.

4. The light beam emitter of claim 3, wherein said light deflection disk is formed with an anti-reflection film over at least one of the disk surfaces.

5. The light beam emitter of claim 3, wherein said light deflection disk is formed with inclined surfaces that are inclined in at lease one of the directions, radial and/or circumferential directions, to refract the incident light beam in predetermined directions.

6. The light beam emitter of claim 5, wherein only one side of said light deflection disk is formed as said light deflective disk surface.

7. The light beam emitter of claim 5, wherein said inclined surface is formed so as to satisfy the relation,
sin(θw+θs)=n·sin θw
where θw is the angle of inclination which said inclined surface makes with said deflective disk surface, θs is the angle which the light beam makes with the normal of said deflective disk surface as it exits from said transmissive light deflection disk, and n is an index of refraction of said transmissive light deflection disk.

8. The light beam emitter of claim 5, wherein said inclined surface is formed with a different angle in each of a plurality of light deflection areas which are divided in the circumferential direction.

9. The light beam emitter of claim 8, wherein the angle of inclination of said inclined surface is increased or decreased in said plurality of light deflection areas along the circumferential direction.

10. The light beam emitter of claim 5, wherein said inclined surface is formed as a continuous surface, in which the angle of inclination changes continuously in the circumferential direction.

11. The light beam emitter of claim 2, wherein said light deflection disk has a track thereon that can direct the incident light beam in different directions depending on the incident positions of the beam.

12. The light beam emitter of claim 2, wherein said light source device is provided as single and said light source device irradiates a light beam onto one place of said track in the circumferential direction.

13. The light beam emitter of claim 2, wherein said light source device is provided as multiple in order to irradiate a light beam onto each of a plurality places on said track in the circumferential direction.

14. The light beam emitter of claim 2, wherein said light source device is provided as single and is equipped with an optical path splitter that splits the beam emitted by said light source toward each of the said plurality of places on said track in the circumferential direction so that a light beam is irradiated onto each of the said plurality of places on said track in the circumferential direction.

15. The light beam emitter of claim 2, wherein said light source device is provided as single and a light source drive mechanism is provided for rotating said light source device or driving it in a straight line so that a light beam is irradiated onto each of a plurality of places of said track in the circumferential direction.

16. The light beam emitter of claim 2, wherein said light deflection disk has a plurality of tracks that is formed concentrically and can direct the incident light beam toward different positions depending on the incident positions of the beam, and said light source device is constructed as multiple units in order to irradiate a light beam onto each of said plurality of tracks.

17. The light beam emitter of claim 2, wherein said light deflection disk has a plurality of tracks that is formed concentrically and can direct the incident light beam toward different positions depending on the incident positions of the beam, and said light source device is provided as a single unit and equipped with an optical path splitter that splits the beam emitted by said light source toward each of the said plurality of places on said track in the circumferential direction so that a light beam is irradiated onto each of the said plurality of places on said track in the circumferential direction.

18. The light beam emitter of claim 2, wherein said light deflection disk has a plurality of tracks that is formed concentrically and can direct the incident light beam toward different positions depending on the incident positions of the beam, and said light source device is provided as a single unit and a light source drive mechanism is provided for rotating said light source device or driving it in a straight line so that a light beam is irradiated onto each of the said plurality of places on said track in the circumferential direction.

19. The light beam emitter of claim 2, wherein said deflective disk surface is constructed according to a pattern in which said light deflection disk directs the light beam (the exiting pattern of the light beam).

20. The light beam emitter of claim 2, wherein said deflective disk surface is constructed so as to direct the incident light beam toward each position arranged in a matrix pattern, and said light source device emits a light beam at the timing corresponding to said exiting pattern of the light beam from said light deflection disk so that said light beam selectively enters predetermined positions on said deflective disk surface.

21. The light beam emitter of claim 2, wherein said light source device has said light source and a collimating lens that guides the light beam emitted by said light source onto said deflective disk surface as collimated beam.

22. The light beam emitter of claim 2 wherein said light source device has said light source and a condensing lens that guides the light beam emitted by said light source onto said deflective disk surface as a converged beam in the perpendicular direction, in the horizontal direction, or in both perpendicular and horizontal directions of the light beam emitted by said light source.

23. The light beam emitter of claim 22, wherein said converged beam focuses on said deflective disk surface or in the vicinity of said deflective disk surface in the perpendicular and horizontal directions of the light beam emitted by said light source.

24. The light beam emitter of claim 2, wherein said light beam has a beam size of 3 mm or less on said deflective disk surface in the circumferential direction.

25. The light beam emitter of claim 2, wherein said light beam has a beam size of 3 mm or less on said deflective disk surface in the circumferential and radial directions.

26. The light beam emitter of claim 2, wherein said light deflection disk is made of resin.

27. The light beam emitter of claim 2, wherein a position detector is also provided to detect the position of rotation of said light deflection disk, and the rotation of said light deflection disk is controlled based on the result of the detection by said position detector.

28. An image-forming device equipped with the light beam emitter of claim 1, wherein an image is formed with the light beams directed by said light deflection mechanism.

29. A method for directing a light beam comprising the steps of:
emitting a light beam from a light source device;
directing the light beam emitted by the light source in any direction;
deflecting the light beam toward different positions on the 2D coordinate system depending on a plurality of incident positions of the light beam; and
changing the incident positions of the light beam.
